(19) United States
(12) Patent Application Publication
(10) Pub. No.: US 2019/0284983 A1
(43) Pub. Date: Sep. 19, 2019

(54) SYSTEM AND METHOD FOR INSULATING INDUSTRIAL ENGINES

(71) Applicant: Griffin Insulation Co., Inc., Rochester, NY (US)

(72) Inventor: Richard Mullen, Baldwinsville, NY (US)

(73) Assignee: Griffin Insulation Co., Inc., Rochester, NY (US)

(21) Appl. No.: 16/354,720

(22) Filed: Mar. 15, 2019

Related U.S. Application Data
(60) Provisional application No. 62/643,445, filed on Mar. 15, 2018.

(51) Int. Cl. F01N 13/14; F16L 59/02; F01N 13/10; F02B 77/08; F02B 77/11; B32B 15/14; F16B 5/00

(52) U.S. Cl. CPC F01N 13/148; F16L 59/026; F01N 13/102; F02B 77/083; B32B 2315/085; B32B 15/14; F16B 5/0036; F01N 2510/02; F01N 2310/14; F02B 77/11

(57) ABSTRACT

Systems and methods for insulating large industrial engines. In various embodiments, the disclosure provides a blanket system including a blanket having three layers. The first layer is composed of ceramic fibers. The second layer is composed of fiberglass cloth and the third layer is composed of wire mesh. The blanket also has a first leading edge and an opposing second leading edge. The second leading edge is substantially parallel to the first leading edge. The blanket also includes a locking mechanism having a movable portion between aligned first and second stationary portions on an outer surface of the blanket. In an unlocked position, the movable portion is connected to the first stationary portion. In a locked position, the movable portion is connected to both the first and second stationary portions and the locking mechanism extends over the first and second leading edges.

### CROSS-REFERENCE TO RELATED APPLICATIONS

This application claims priority to U.S. Provisional Patent Application Ser. No. 62/643,445, filed on Mar. 15, 2018 and entitled “System and Method for Insulating Industrial Engines,” the entirety of which is incorporated herein by reference.

### BACKGROUND OF THE INVENTION

### 1. Field of the Invention

The present invention is directed generally to a system and method for insulating large machinery and, more particularly, to a heat resistant blanket system to removably surround the exhaust system of industrial engines.

### 2. Description of Related Art

Large industrial engines are used to power manufacturing equipment to execute a number of manufacturing processes. Large industrial engines run at high operating temperatures (e.g., approximately 850° F.) and are typically exposed to harsh environments. Due to the exposure and extreme temperature, in addition to traditional engine wear and tear, large industrial engines require more frequent routine maintenance. As the engine is often the sole driving mechanism for large-scale manufacturing, time that the engine is inoperable for repair must be minimized.

Currently, it is common that large industrial engines are supplied with insulation (e.g., Original Equipment Manufacturer (OEM) product) when first installed. However, the insulation must be removed and replaced with new insulation each time maintenance is conducted. Thus, the labor required to maintain the engine includes removing the old insulation, and providing and installing the new insulation in addition to any labor on the actual machinery of the engine. Consequently, the overall cost to maintain large industrial engines is significant.

Therefore, there is a need to reduce the overall cost of maintenance for large industrial engines and streamline the process for insulating the engines. This system accomplishes this by allowing installation with minimal training or experience in installing insulating systems.

### SUMMARY OF THE INVENTION

The present invention is directed to systems and method for insulating large industrial engines. According to one aspect, the present invention is a blanket system. The blanket system includes a blanket having three layers. The first layer is composed of ceramic fibers. The second layer is composed of fiberglass cloth and the third layer is composed of wire mesh. The blanket also has a first leading edge and an opposing second leading edge. The second leading edge is substantially parallel to the first leading edge. The blanket also includes a locking mechanism having a movable portion between aligned first and second stationary portions on an outer surface of the blanket. In an unlocked position, the movable portion is connected to the first stationary portion. In a locked position, the movable portion is connected to both the first and second stationary portions and the locking mechanism extends over the first and second leading edges.

These and other aspects of the invention will be apparent from and elucidated with reference to the embodiment(s) described hereinafter.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following description taken in conjunction with the accompanying drawings in which:

FIG. 1 is a perspective view of an outer surface of the blanket system;

FIG. 2 is a close-up view of the three layers of the blanket;

FIG. 3 is a close-up perspective view of the movable portion of the locking mechanism in the unlocked position;

FIG. 4 is a perspective view of the components of the locking mechanism;

FIG. 5 is a perspective view of a round lacing anchor;

FIG. 6 is a perspective view of a rectangular lacing anchor;

FIG. 7 is a perspective view of an auxiliary pad of the blanket system;

FIG. 8 is a front view of an industrial engine without the blanket system;

FIG. 9 is a front side view of the industrial engine of FIG. 8 with the blanket system;

FIG. 10 is a top view of the blanket system in the locked position;

FIG. 11 is a top view of a first lower accessory of the blanket system, according to an embodiment;

FIG. 12 is a top view of a first bottom accessory of the blanket system, according to an embodiment;

FIG. 13 is a top view of a first front accessory of the blanket system, according to an embodiment;

FIG. 14 is a top view of a first side accessory of the blanket system, according to an embodiment;

FIG. 15 is a top view of a second lower accessory of the blanket system, according to an embodiment;

FIG. 16 is a top view of a second bottom accessory of the blanket system, according to an embodiment;

FIG. 17 is a top view of a first upper accessory of the blanket system, according to an embodiment;

FIG. 18 is a top view of a second side accessory of the blanket system, according to an embodiment;

FIG. 19 is a top view of a top accessory of the blanket system, according to an embodiment;

FIG. 20 is a top view of a back accessory of the blanket system, according to an embodiment;

FIG. 21 is a top view of a third side accessory of the blanket system, according to an embodiment;

FIG. 22 is a top view of an end cap accessory of the blanket system, according to an embodiment;

FIG. 23 is a top view of a fourth side accessory of the blanket system, according to an embodiment;

FIG. 24 is a top view of a top accessory of the blanket system, according to an alternative embodiment;

FIG. 25 is a top view of a first side accessory of the blanket system, according to an alternative embodiment;

FIG. 26 is a top view of a second side accessory of the blanket system, according to an alternative embodiment;

FIG. 27 is a top view of a third side accessory of the blanket system, according to an alternative embodiment;

FIG. 28 is a top view of a fourth side accessory of the blanket system, according to an alternative embodiment;

FIG. 29 is a top view of a fifth side accessory of the blanket system, according to an alternative embodiment;

FIG. 30 is a top view of an end cap accessory of the blanket system, according to an alternative embodiment;

FIG. 31 is a top view of an exhaust pad accessory of the blanket system, according to an alternative embodiment;

FIG. 32 is a top view of an strap accessory of the blanket system, according to an alternative embodiment; and

FIG. 33 is a side view of a conventional manifold pad of the prior art.

### DETAILED DESCRIPTION OF THE INVENTION

Aspects of the present invention and certain features, advantages, and details thereof, are explained more fully below with reference to the non-limiting examples illustrated in the accompanying drawings. Descriptions of well-known structures are omitted so as not to unnecessarily obscure the invention in detail. It should be understood, however, that the detailed description and the specific non-limiting examples, while indicating aspects of the invention, are given by way of illustration only, and are not by way of limitation. Various substitutions, modifications, additions, and/or arrangements, within the spirit and/or scope of the underlying inventive concepts will be apparent to those skilled in the art from this disclosure.

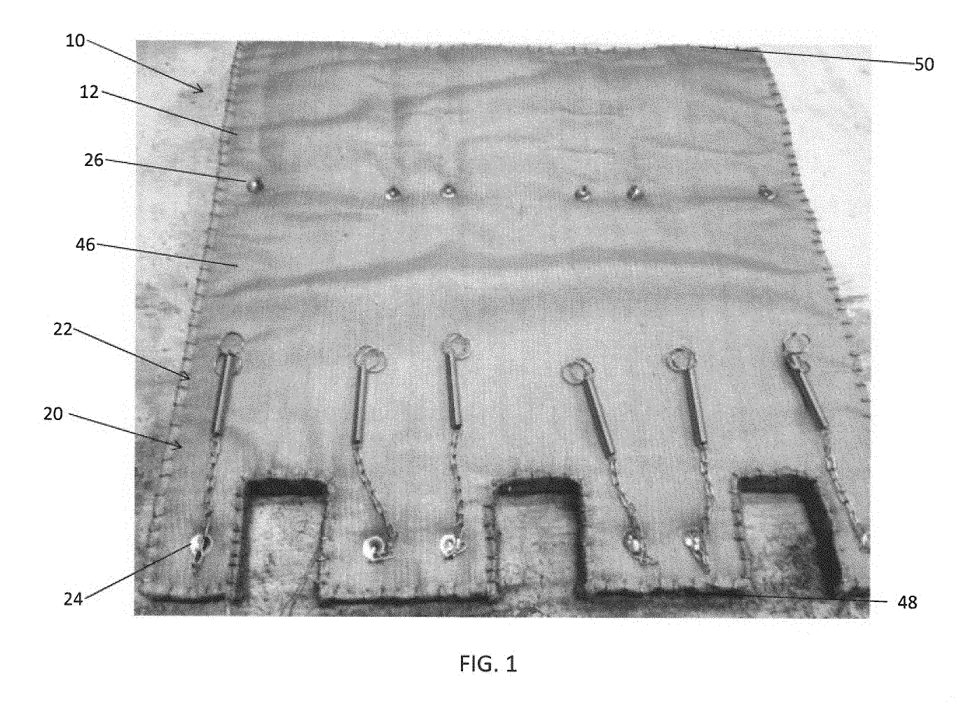

Referring now to the figures, wherein like reference numerals refer to like parts throughout, FIG. 1 shows a perspective view of an outer surface 46 of the blanket system 10 for insulating industrial engines. In particular, FIG. 1 shows an illustrative embodiment of a blanket system 10 used to removably insulate large catalytic converters and other large machinery. As shown, the blanket system 10 includes a blanket 12 composed of three layers of material.

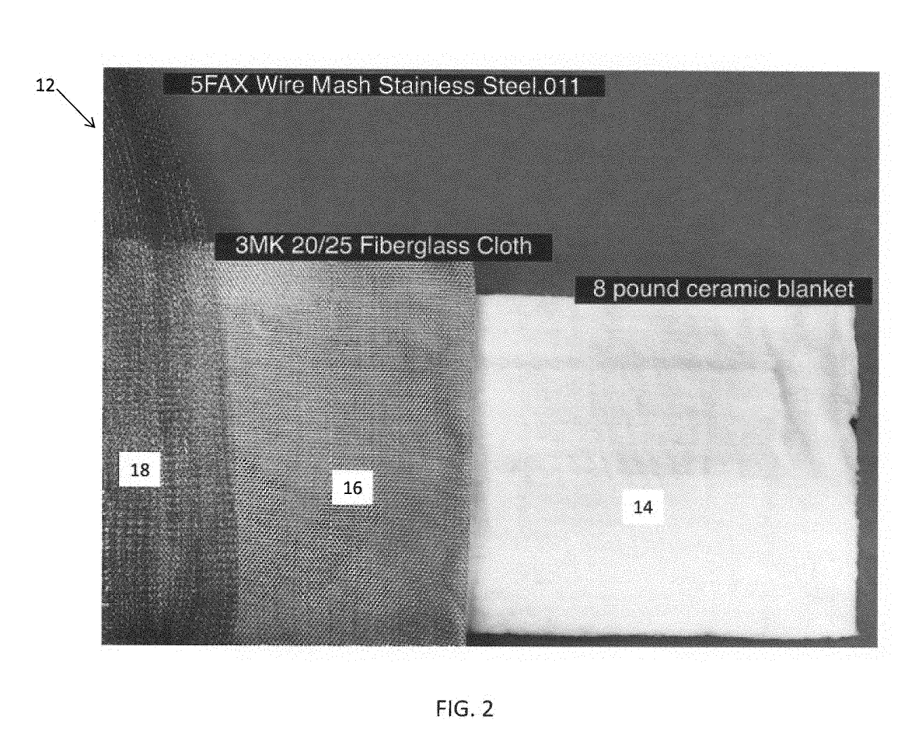

Referring now to FIG. 2 there is shown a close-up view of the three layers of the blanket 12. The first layer 14 of the blanket 12 is composed of a high-temperature resistant insulating material. In one exemplary embodiment, the first layer 14 is composed of ceramic fiber products such as Durablanket®. Durablanket® is spun from Fiberfrax® ceramic fibers, which are extra-long spun fibers cross-locked to provide strength. Durablanket® is made entirely of inorganic materials and can be manufactured for a variety of temperature grades, densities, and sizes. Certain varieties of the Durablanket® can withstand temperatures of up to 2600° F. (1430° C.), making it an ideal composition for insulating industrial engines and other large machinery. In one embodiment, a Durablanket® that is 2 inches thick and 8 pcf. is used in the blanket system 10.

The second layer 16 of the blanket 12 is composed of fiberglass cloth. In one exemplary embodiment, the second layer 16 is woven fiberglass cloth such as that manufactured by Great Lakes Textiles. The fiberglass cloth is heat resistant up to temperatures of 1000° F. and is used as a jacketing material to cover insulated surfaces, such as the first layer 14 of the blanket 12.

The third layer 18 of the blanket 12 is composed of wire mesh. In one exemplary embodiment, the third layer 18 is stainless steel mesh such as that manufactured by Great Lakes Textiles. The third layer 18 serves as an outer envelope of the blanket 12. The wires comprising the wire mesh allow the third layer 18 to be flexible and conform to irregular shaped surfaces. In addition, in embodiments wherein the wire mesh is composed of stainless steel, the stainless steel can withstand the stress of repeated rounds of removal and installation around an engine (or other large machine). The wires comprising the mesh may range from 0.011 to 0.006 inches in diameter depending on the desired flexibility. Such wires can withstand 900° F.-1200° F. of continuous heat and 1200° F.-1500° F. of intermittent heat. Other alloys may be utilized for the third layer 18, such as nickel alloys like Monel and Inconel, which can withstand temperatures of up to 2000° F. and 2300° F., respectively, but are less flexible. The selection of composition of the wire mesh and the diameter of the wires depends on the desired flexibility.

Referring back to FIG. 1, the blanket system 10 additionally comprises one or more locking mechanisms 20 for securing the blanket 12 around an industrial engine. Each locking mechanism 20 comprises a movable portion 22 removably attached to first and second stationary portions 24, 26. In the depicted embodiment, the first stationary portion 24 and the secondary portion 26 are spaced and aligned. However, alternative embodiments are contemplated wherein the first and second stationary portions 24, 26 are not aligned. The locking mechanism 20 shown in FIG. 1 is in the unlocked position. In the unlocked position, the movable portion 22 is only connected to the first stationary portion 24.

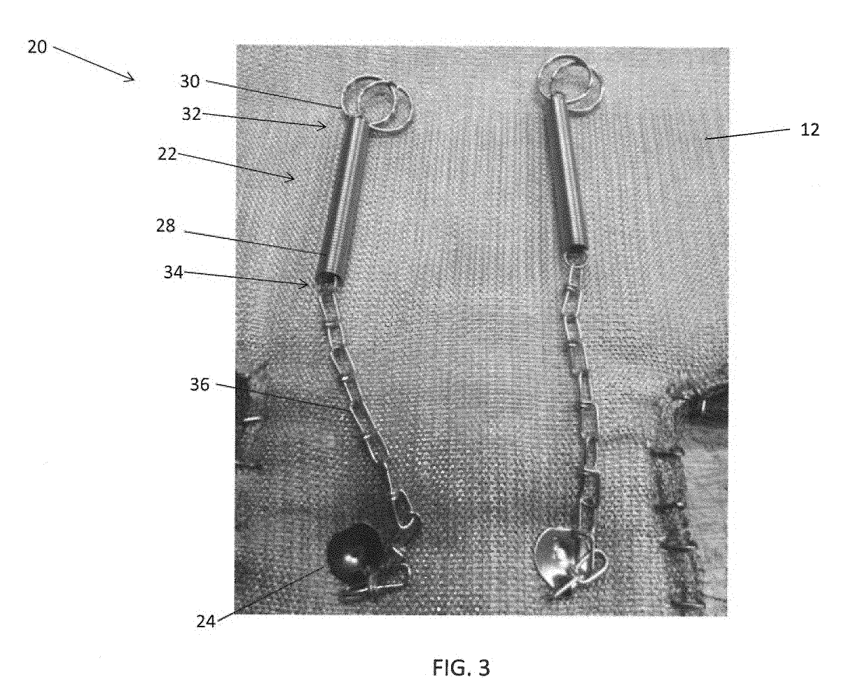

Turning now to FIG. 3, there is shown a close-up perspective view of the movable portion 22 of the locking mechanism 20 in the unlocked position. In the depicted embodiment, the movable portion 22 is a spring 28 having a first end 32 and a second end 34. The spring 28 may be composed of heat resistant material, such as stainless steel. For example, the spring 28 is a stainless steel spring which is 4.5 inches in length and has wires having a diameter of 0.063 inches. The first end 32 of the spring 28 is connected to one or more rings 30. In the depicted embodiment, the spring 28 is connected to two rings 30. For ease of blanket installation, one ring 30 is used as a hand hold the other ring 30 is left free to be caught and held by the second stationary portion 26 while being installed on the engine. In the depicted embodiment, the rings 30 are composed of stainless steel.

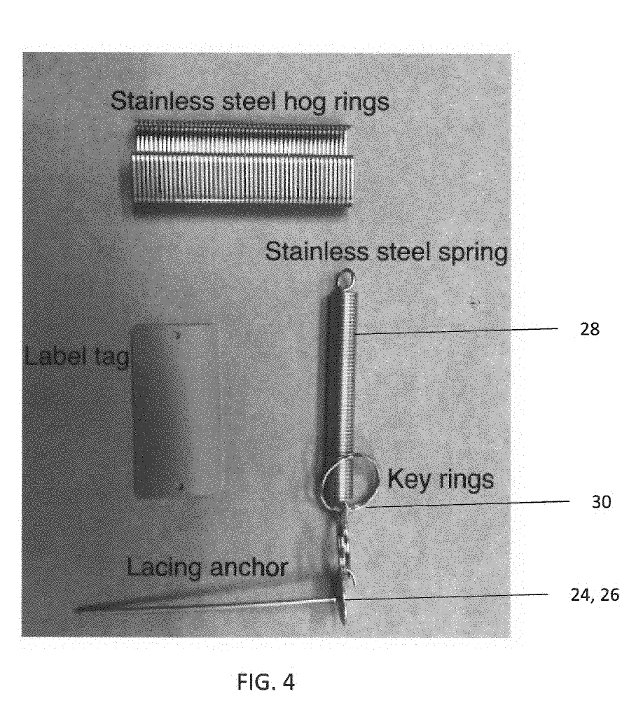

The second end 34 of the spring 28 is connected to a chain 36. Although a metal chain 36 is shown in FIG. 3, any heat resistant and flexible cable or connecting material can be used. In the depicted embodiment, the chain 36 is a double loop zinc-plated chain 36. The chain 36 connects the second end 34 of the spring 28 to the first stationary portion 24. In the depicted embodiment, the first stationary portion 24 (and second stationary portion 26 in FIG. 1) is a lacing anchor. The components of the locking mechanism 22 are shown separately in FIG. 4.

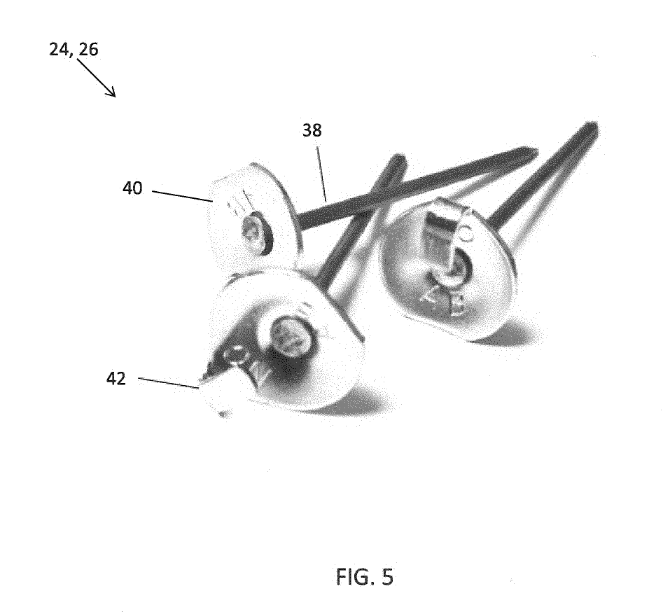

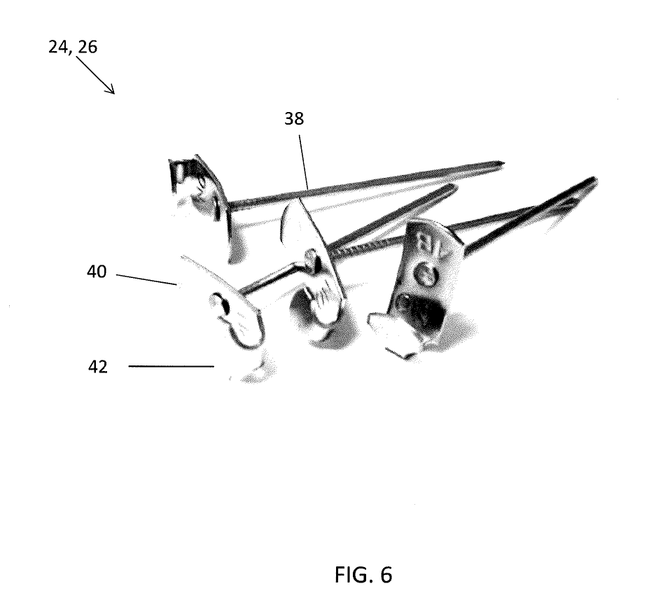

Referring now to FIGS. 5-6, there are shown perspective views of illustrative embodiments of the lacing anchor 24, 26. The lacing anchor 24, 26 in FIG. 4 is a round stainless steel lacing anchor 24, 26 that is 4.5 inches in length and has a 14 gauge diameter. Other metals may be used, such as low carbon steel, and the any size combinations of the lacing anchor 24, 26 may be used depending on the size of the industrial engine or other large machine. As shown in FIG. 5, the lacing anchor 24, 26 may also be rectangular. Traditional lacing anchors 24, 26, such as the lacing anchors 24, 26 shown in FIGS. 4-5, have a pin 38 connected to a flat plate 40. The pin 38 extends through from a connector on the inner surface of the blanket (not shown) to the outer surface 46 and connects to the center of the flat plate 40. As stated above, the flat plate 40 is round (in FIG. 4) or rectangular (in FIG. 5). The lacing anchors 24, 26 also comprise a hook 42 extending from the flat plate 40.

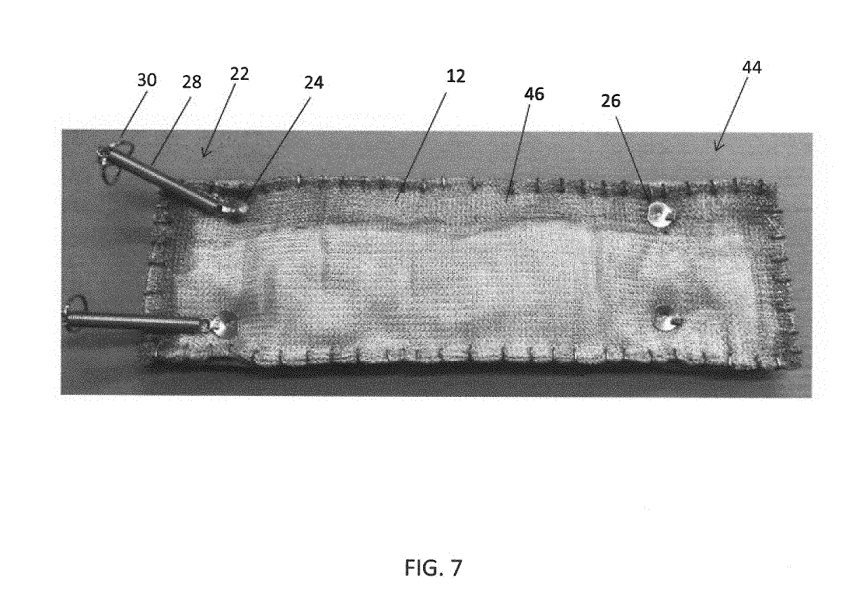

Referring now to FIG. 7, there is shown a top view of an auxiliary pad 44 of the blanket system 10. The auxiliary pad 44 is similar to the blanket 12 of the system 10 and is used to cover smaller portions of the industrial machine, such as a manifold exhaust. In the depicted embodiment, auxiliary pad 44 is composed of the first, second, and third layers 14, 16, 18 of the blanket 12, as described above, with a condensed version of the locking mechanism 22 shown in FIG. 2. The locking mechanism 22 on the auxiliary pad 44 comprises both the first and second stationary portions 24, 26. In the depicted embodiment, the first and second stationary portions 24, 26 are aligned, although it is not required. The locking mechanism 22 in FIG. 7 differs from that in FIG. 3 in that the locking mechanism 22 in FIG. 7 comprises a spring 28 which is directly attached to the first stationary portion 24. The chain 36 in the locking mechanism 22 in the FIG. 3 is not required for the auxiliary pad 44 because the auxiliary pad 44 is smaller in size relative to the blanket 12 and does not require a chain 36 to extend the length of the locking mechanism 22.

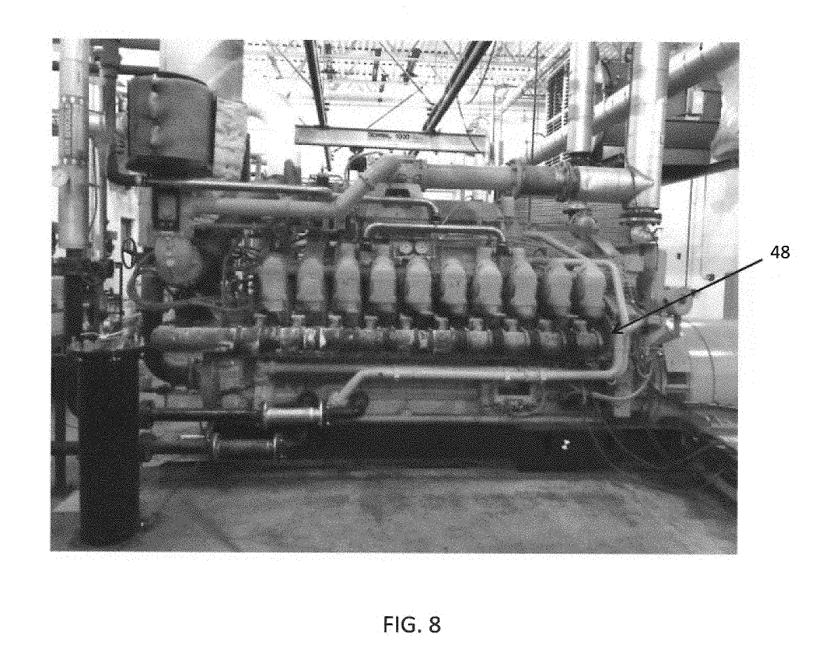

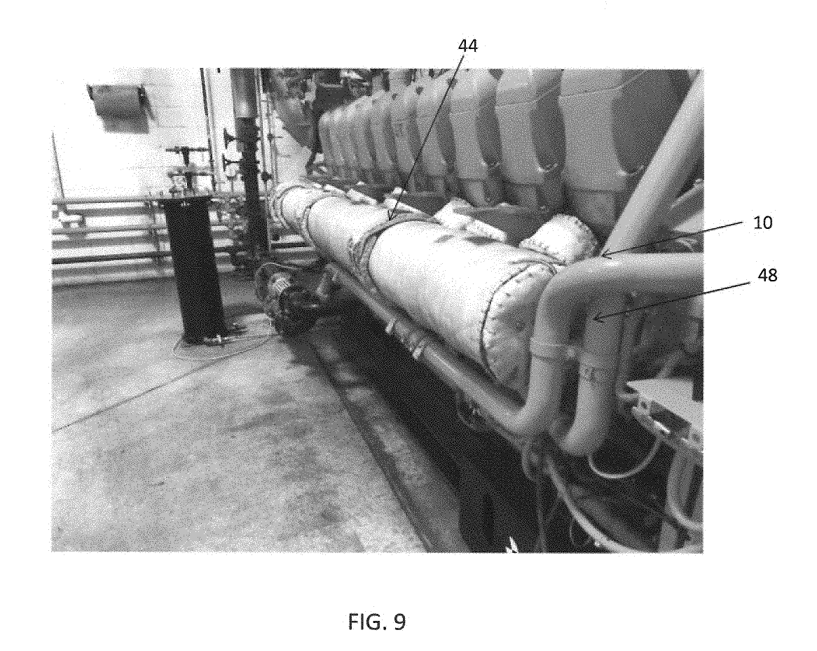

Referring now to FIGS. 8-10, there are shown perspective views of an industrial engine with and without the blanket system 10. FIG. 8 depicts an industrial engine 48 exposed without any insulation. To employ the blanket system 10 to insulate an industrial engine 48 (or other large machine), the blanket system 10 is in the unlocked position (as shown in FIG. 2) and draped over the industrial engine 48 with the outer surface 46 (shown in FIGS. 1 and 7) facing outward toward the environment. From the unlocked position, the spring 28 is stretched toward the second stationary portion 26. To lock the blanket system 10 in the locked position, the ring 30 is placed around the hook 42 of the second stationary portion 26. In embodiments wherein the blanket system 10 has multiple locking mechanisms 22, one ring 30 is secured around one hook 42 of the aligned second stationary portion 26 of the blanket 12 (or auxiliary pad 44), as shown in FIG. 9.

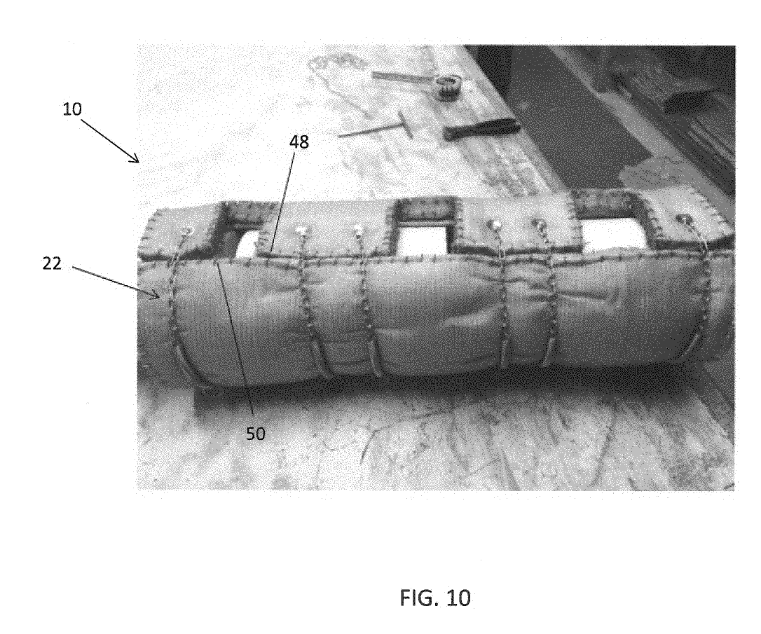

Turning briefly to FIG. 10, there is shown a top view of the blanket system 10 in the locked position. The blanket system 10 includes a first leading edge 48 and an opposing second leading edge 50. In the depicted embodiment, the first leading edge 48 is substantially parallel to the second leading edge 50. In other embodiments wherein the blanket system 10 is a shape other than rectangular, the first and second leading edges 48, 50 may not be substantially parallel. However, in order to maintain the blanket system 10 in the locked position, the locking mechanism 22 must extend over both the first leading edge 48 and the second leading edge 50, as shown in FIG. 10.

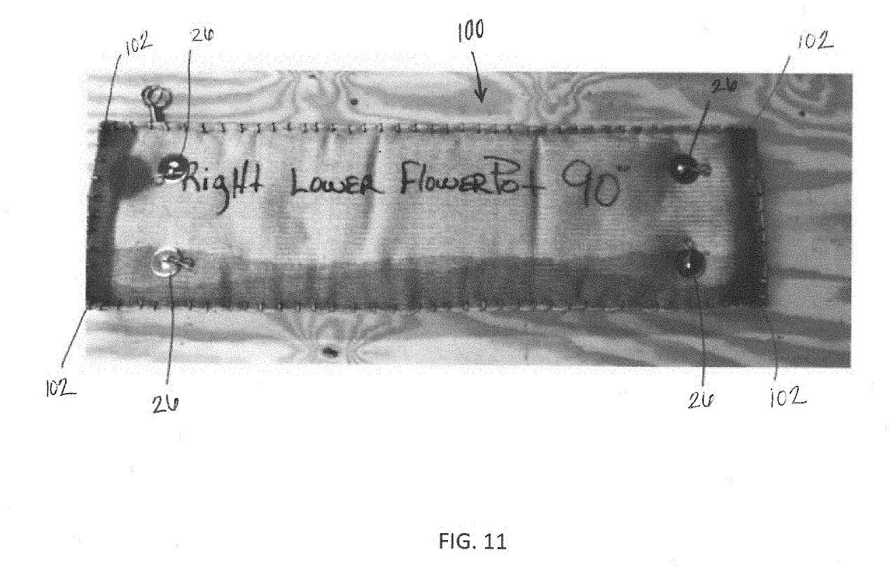

Referring now to FIGS. 11-23, there are shown top views of accessory components of the blanket system 10, according to an embodiment. The accessory components shown in FIGS. 11-23 are termed a “flower pot” embodiment. The accessory components in FIGS. 11-23 are composed of the same three layers of material as the blanket 12 (described above). The accessory components shown in FIGS. 11-23 can be used alone or together, as needed, to completely insulate an industrial engine. In other words, the accessory components are used to insulate portions of the industrial engine that are exposed after installation of the blanket system 10 (as understood by one of ordinary skill in the art). In addition, each accessory component can be individually replaced after wear.

FIG. 11 shows a top view of a first lower accessory 100 of the blanket system 10. In the depicted embodiment, the first lower accessory 100 is rectangular. The first lower accessory 100 comprises one or more stationary portions 26, such as lacing anchors. In the embodiment, the first lower accessory 100 comprises four stationary portions 26, one near each corner 102 of the rectangular first lower accessory 100. (Note, although only some aspects of the locking mechanism 20 (FIG. 1) are shown in FIGS. 11-23 with respect to the accessory components, the accessory components in FIGS. 11-23 may comprise any and all features of the locking mechanism 20 shown in FIG. 1 (e.g., movable portion 22, first stationary portion 24, and second stationary portion 26) so that each accessory component can be removably attached to an industrial engine).

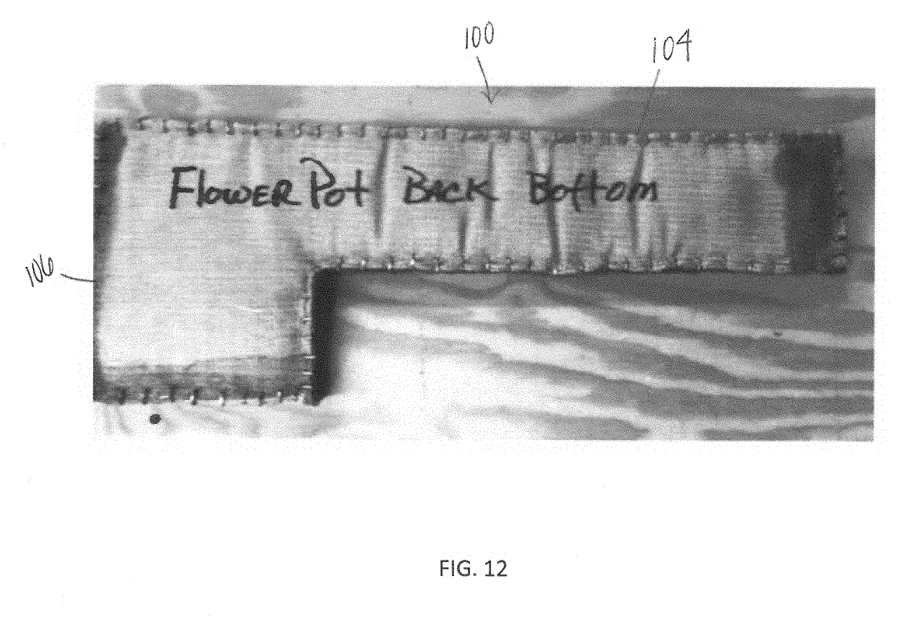

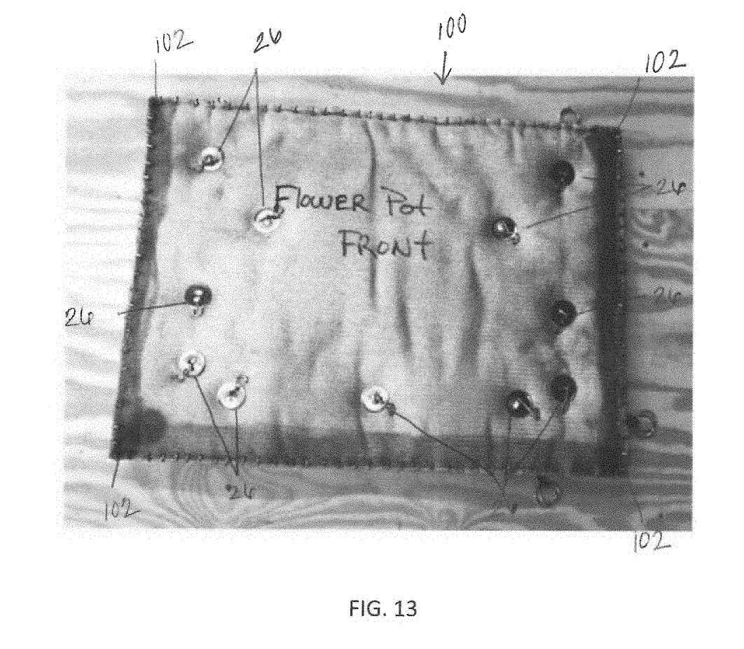

FIG. 12 shows a top view of a first bottom accessory 100. In the depicted embodiment, the first bottom accessory 100 is L-shaped with a first rectangular portion 104 extending perpendicular from a second rectangular portion 106. FIG. 13 shows a top view of a first front accessory 100. In the depicted embodiment, the first front accessory 100 is rectangular. Specifically, the first front accessory 100 in FIG. 13 is square. The first front accessory 100 comprises a plurality of stationary portions 26, such as lacing anchors. In the embodiment, the first front accessory 100 comprises two to three stationary portions 26 near each corner 102 of the rectangular first front accessory 100.

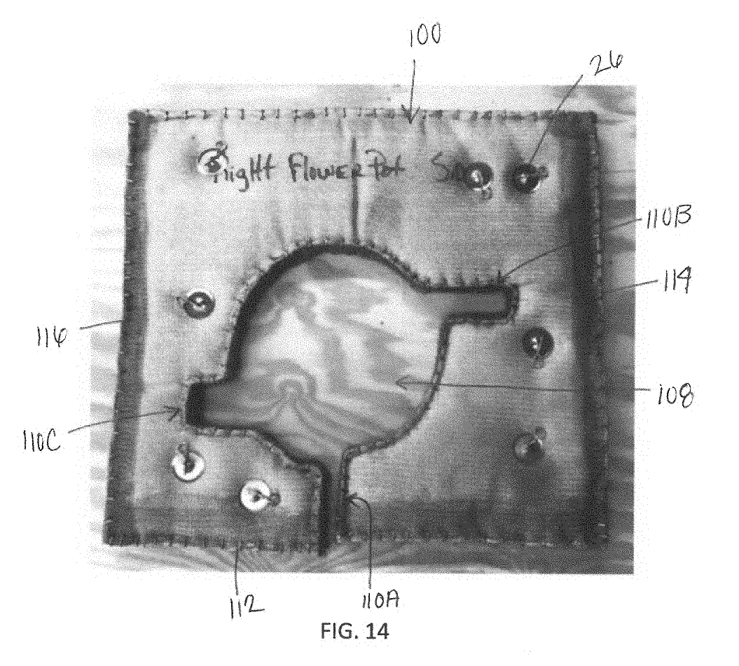

FIG. 14 shows a top view of a first side accessory 100. The first side accessory 100 is rectangular. In the depicted embodiment, the first side accessory 100 is square with an aperture 108 extending therethrough. The aperture 108 through the first side accessory 100 is connected to one or more channels 110. The channels 110 extend through the first side accessory 100. In the depicted embodiment, there are three channels. A first channel 110A extends through the first side accessory 100 and through a first edge 112 of the first side accessory 100. A second channel 110B extends from the aperture 108 and through the first side accessory 100; however, the second channel 110B does not go through any edge of the first side accessory 100. The second channel 110B only extends toward a second edge 114 of the first side accessory 100. The third channel 110C extends from the aperture 108 and through the first side accessory 100 and extends toward a third edge 116 thereof. In the depicted embodiment, the third channel 110C extends parallel to the second channel 110B and the first channel 110A extends perpendicular to the second and third channels 110B, 110C. The first side accessory 100 may also comprise a plurality of stationary portions 26, such as lacing anchors.

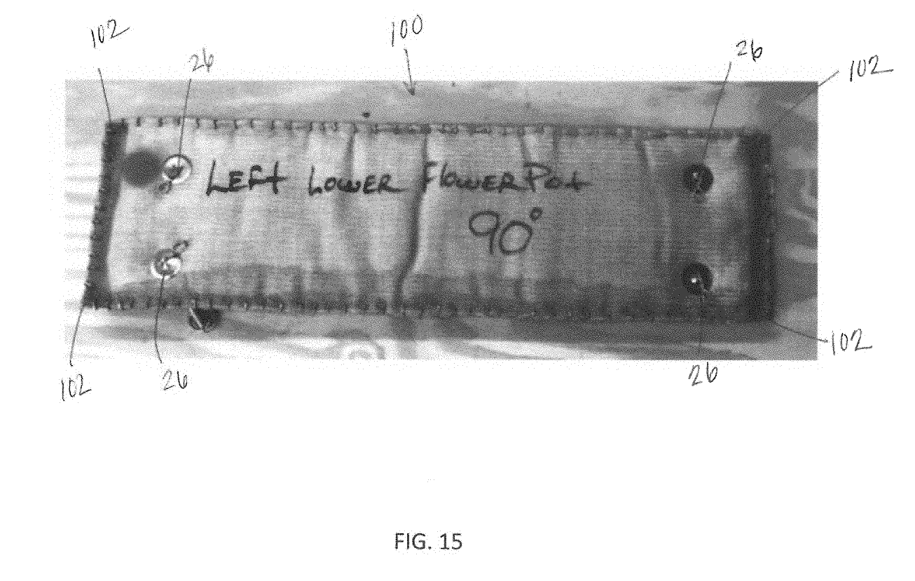

FIG. 15 shows a top view of a second lower accessory 100 of the blanket system 10. In the depicted embodiment, the second lower accessory 100 is rectangular. The second lower accessory 100 comprises one or more stationary portions 26, such as lacing anchors. In the embodiment, the third side accessory 100 comprises four stationary portions 26, one near each corner 102 of the rectangular third side accessory 100.

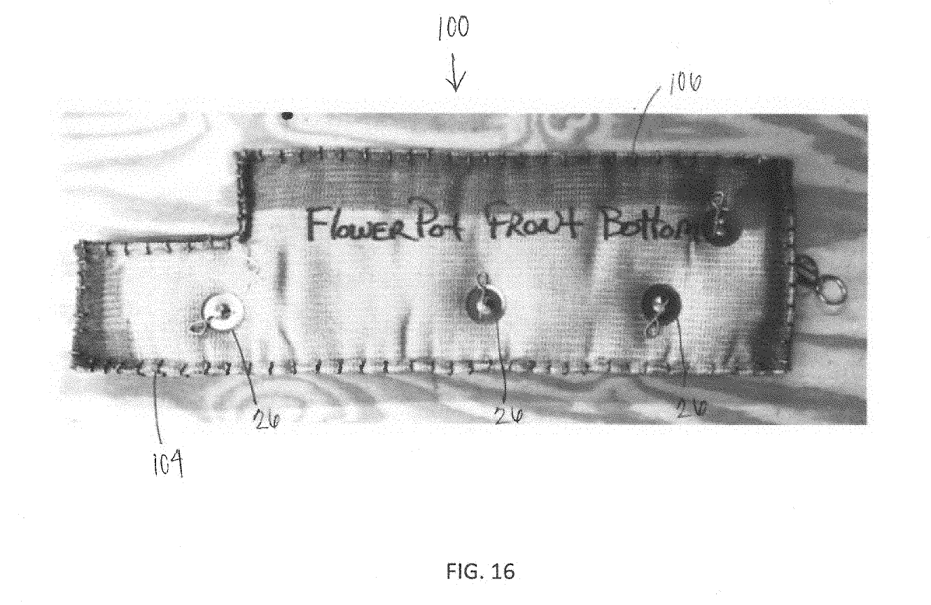

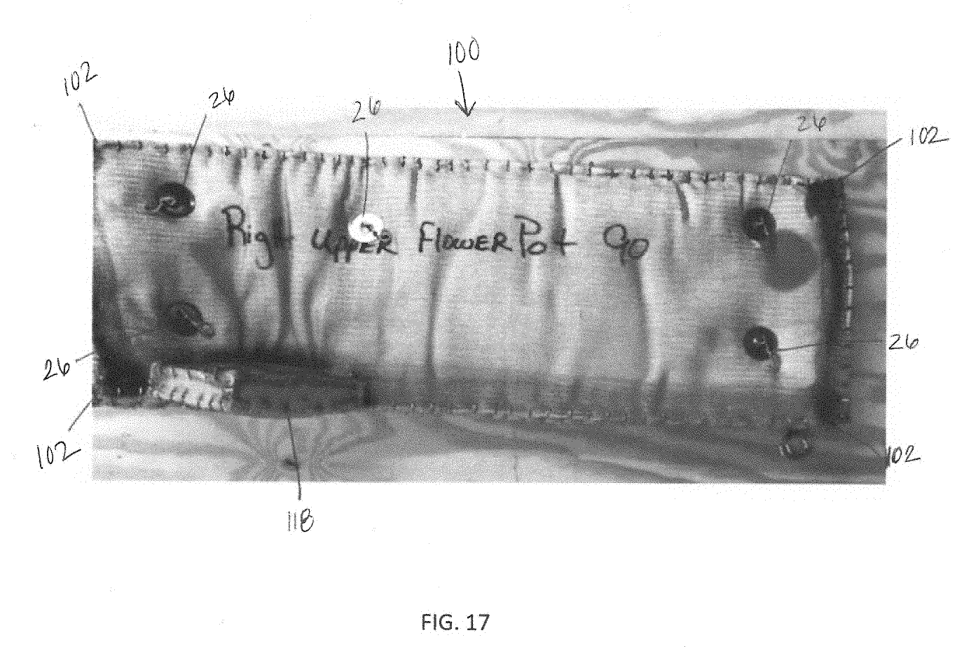

FIG. 16 shows a top view of a second bottom accessory 100. In the depicted embodiment, the second bottom accessory 100 is L-shaped with a first rectangular portion 104 extending perpendicular from a second rectangular portion 106. The second bottom accessory 100 comprises one or more stationary portions 26, such as lacing anchors. FIG. 17 shows a top view of a first upper accessory 100. In the depicted embodiment, the first upper accessory 100 is rectangular. The first upper accessory 100 comprises a plurality of stationary portions 26, such as lacing anchors. In the depicted embodiment, the first upper accessory 100 comprises one stationary portion 26 near each corner 102 of the rectangular first upper accessory 100. As also shown in FIG. 17, the first upper accessory 100 additionally comprises a handle 118. The handle 118 can be composed of the same materials as the first upper accessory 100. In the depicted embodiment, the handle 118 is located near a corner 102 of the rectangular first upper accessory 100.

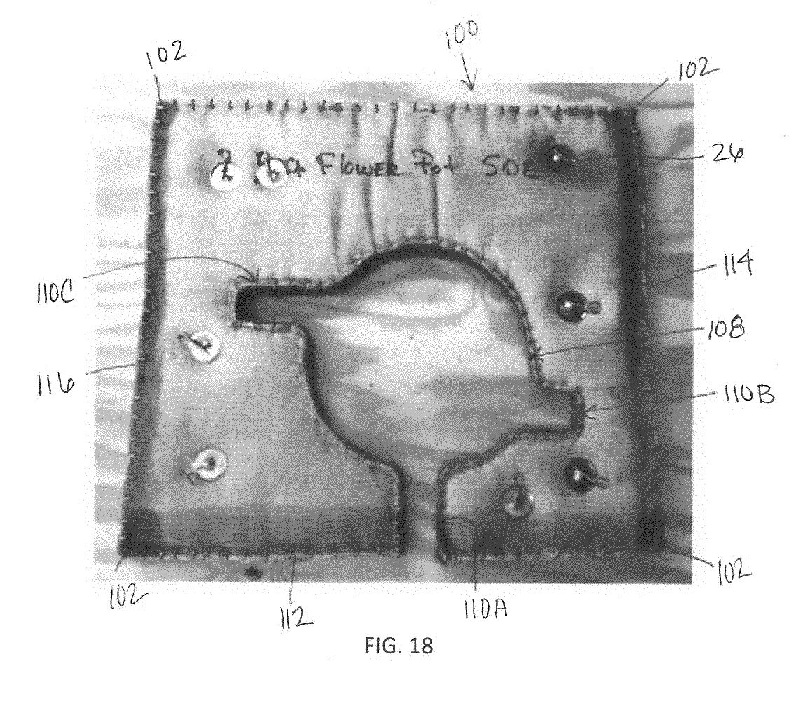

FIG. 18 shows a top view of second side accessory 100. The second side accessory 100 is rectangular. In the depicted embodiment, the second side accessory 100 is square with an aperture 108 extending therethrough. The aperture 108 through the second side accessory 100 is connected to one or more channels 110. The channels 110 extend through the second side accessory 100. In the depicted embodiment, there are three channels. A first channel 110A extends through the second side accessory 100 and through a first edge 112 of the second side accessory 100. A second channel 110B extends from the aperture 108 and through the second side accessory 100; however, the second channel 110B does not go through any edge of the second side accessory 100. The second channel 110B only extends toward a second edge 114 of the second side accessory 100. The third channel 110C extends from the aperture 108 and through the second side accessory 100 and extends toward a third edge 116 thereof. In the depicted embodiment, the third channel 110C extends parallel to the second channel 100B and the first channel 110A extends perpendicular to the second and third channels 110B, 110C. The second side accessory 100 may also comprise a plurality of stationary portions 26, such as lacing anchors.

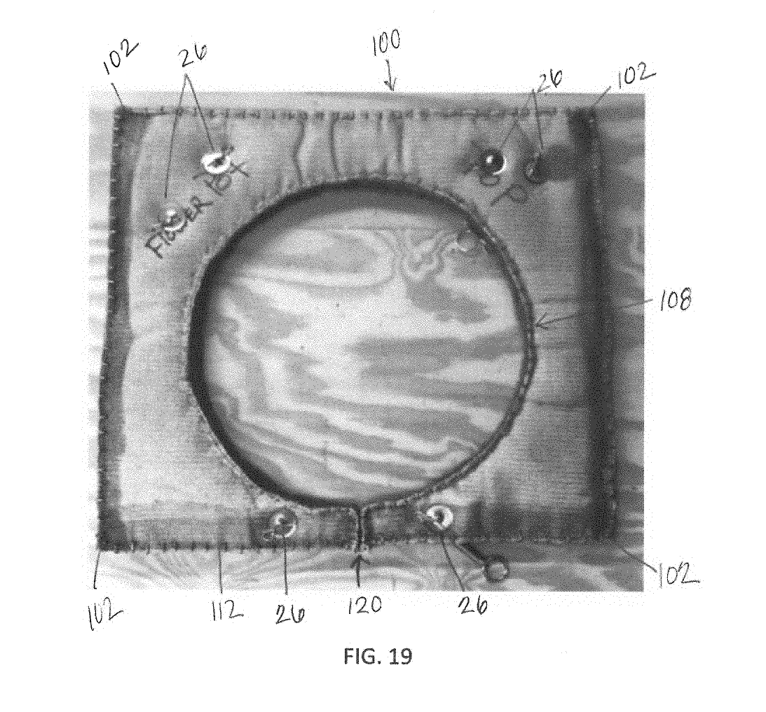

FIG. 19 shows a top view of a top accessory 100. The top accessory 100 is rectangular. In the depicted embodiment, the top accessory 100 is square with an aperture 108 extending therethrough. The aperture 108 is circular and comprises a slit 120 extending from the aperture 108 and through a first edge 112 of the top accessory 100. The top accessory additionally comprises one or more stationary portions 26, such as lacing anchors. In the embodiment, the top accessory 100 comprises a stationary portion 26 on either side of the slit 120. The top accessory 100 also comprises one or more stationary portions 26 in two adjacent corners 102 of the rectangular top accessory 100.

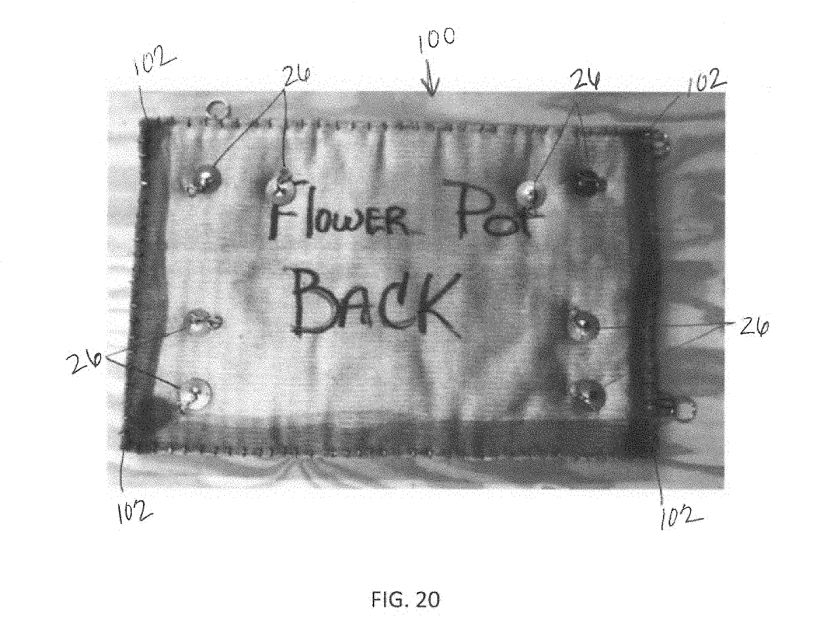

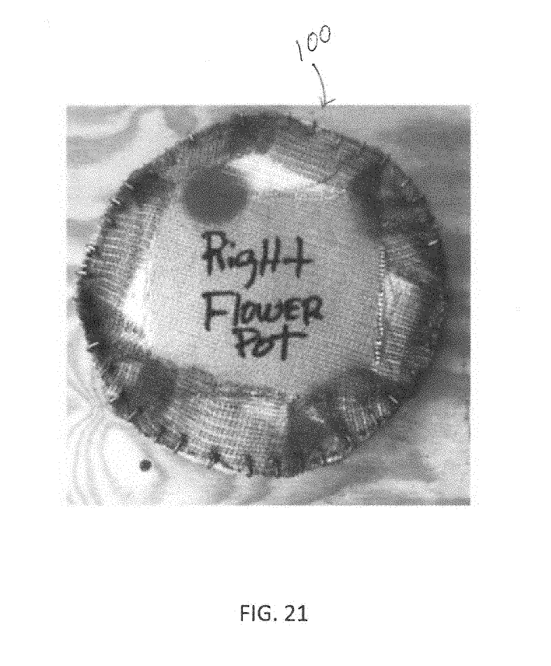

FIG. 20 shows a top view of a back accessory 100. In the depicted embodiment, the back accessory 100 is rectangular. Specifically, the back accessory 100 in FIG. 20 is square. The back accessory 100 comprises a plurality of stationary portions 26, such as lacing anchors. In the embodiment, the back accessory 100 comprises two to three stationary portions 26 near each corner 102 of the rectangular back accessory 100. FIG. 21 shows a top view of a third side accessory 100. In the depicted embodiment, the third side accessory 100 is circular.

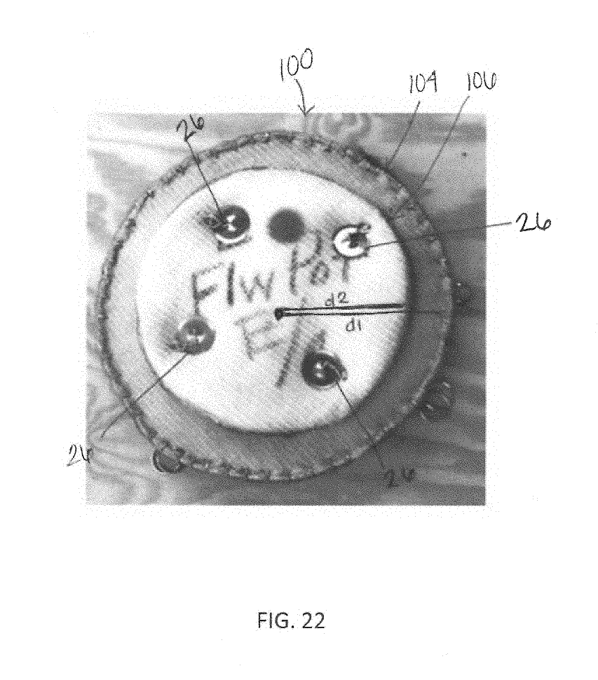

FIG. 22 shows a top view of an end cap accessory 100. The end cap accessory 100 comprises two circular portions, a first portion 104 and a second portion 106. The second portion 106 is stacked onto and attached to the first portion 104. In the depicted embodiment, the second portion 106 is located concentrically on the first portion 104. The first portion 104 has a first diameter d1 and the second portion 106 has a second diameter d2. The second diameter d2 is smaller than the first diameter d1. The end cap accessory 100 comprises a plurality of stationary portions 26, such as lacing anchors. In the embodiment, the stationary portions 26 are on the second portion 106 of the end cap accessory 100.

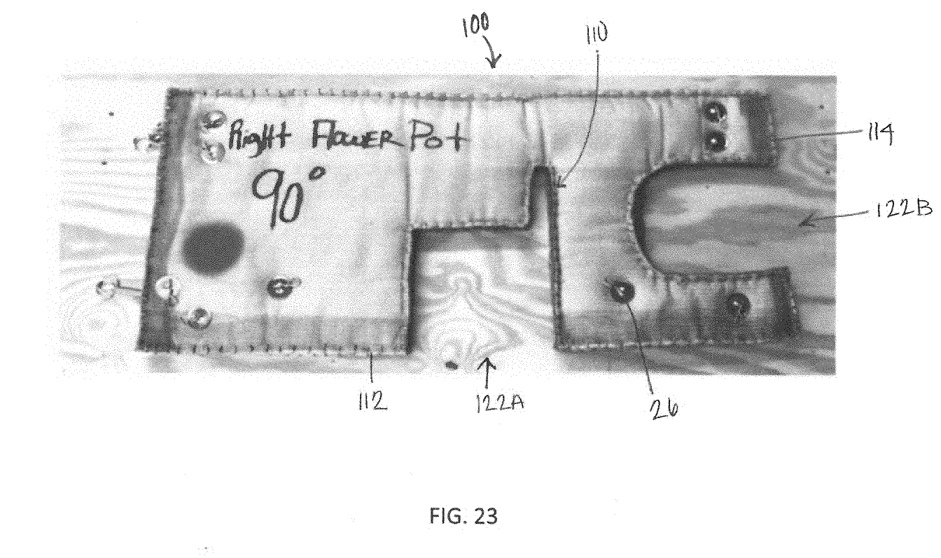

FIG. 23 shows a top view of a fourth side accessory 100. The fourth side accessory 100 has a general rectangular shape. The fourth side accessory 100 comprises at least two cutouts 122. In the depicted embodiment, the fourth side accessory 100 comprises a first cutout 122A, which extends through a first edge 112 of the fourth side accessory 100. The first cutout 112A is rectangular (or square) with a channel 110 extending therefrom. In the depicted embodiment, the channel 110 extends into the fourth side accessory 100. As shown in FIG. 23, the fourth side accessory 100 comprises a second cutout 122B extending through a second edge 114. As also shown, the second cutout 122B is rounded. The fourth side accessory 100 may also comprise a plurality of stationary portions 26, such as lacing anchors.

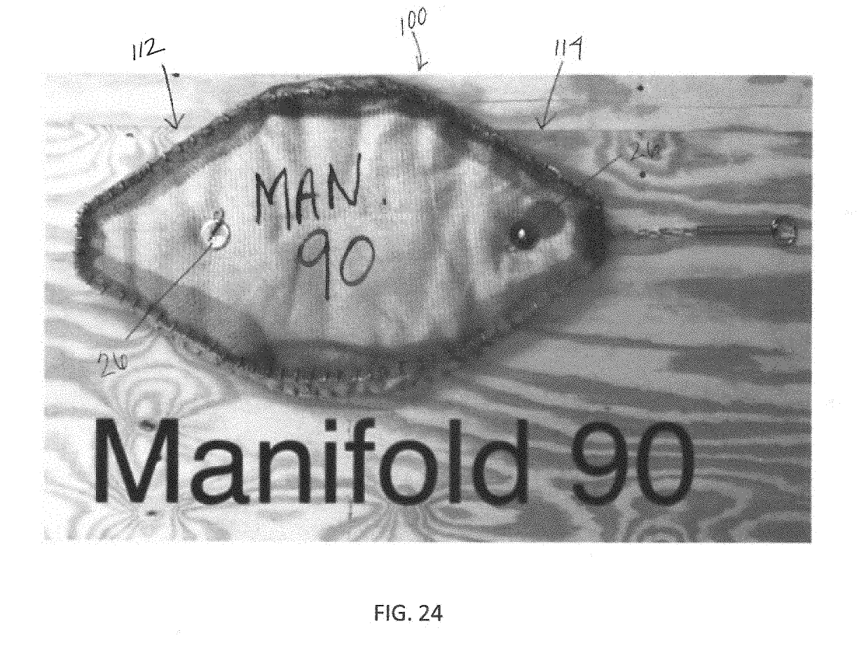

Referring now to FIGS. 24-32, there are shown top views of accessory components of the blanket system 10, according to an alternative embodiment. The accessory components shown in FIGS. 24-32 are termed a “manifold” embodiment. The accessory components in FIGS. 24-32 are composed of the same three layers of material as the blanket 12 (described above). The accessory components shown in FIGS. 24-32 can be used alone or together, as needed, to completely insulate an industrial engine. In other words, the accessory components are used to insulate portions of the industrial engine that are exposed after installation of the blanket system 10 (as understood by one of ordinary skill in the art). In addition, each accessory component can be individually replaced after wear. (Note, although only some aspects of the locking mechanism 20 (FIG. 1) are shown in FIGS. 24-32 with respect to the accessory components, the accessory components in FIGS. 24-32 may comprise any and all features of the locking mechanism 20 shown in FIG. 1 (e.g., movable portion 22, first stationary portion 24, and second stationary portion 26) so that each accessory component can be removably attached to an industrial engine).

Turning first to FIG. 24, there is shown a top view of a top accessory 100. The top accessory 100 is shaped like a diamond or an octagon. In the depicted embodiment, the top accessory 100 is an octagon with a tapered first side 112 and a tapered second side 114. The first side 112 is tapered opposite or in a direction opposing the taper of the second side 114. In other words, the first and second sides 112, 114 are both tapered outward. Each side 112, 114 may also comprise one or more stationary portions 26, such as lacing anchors.

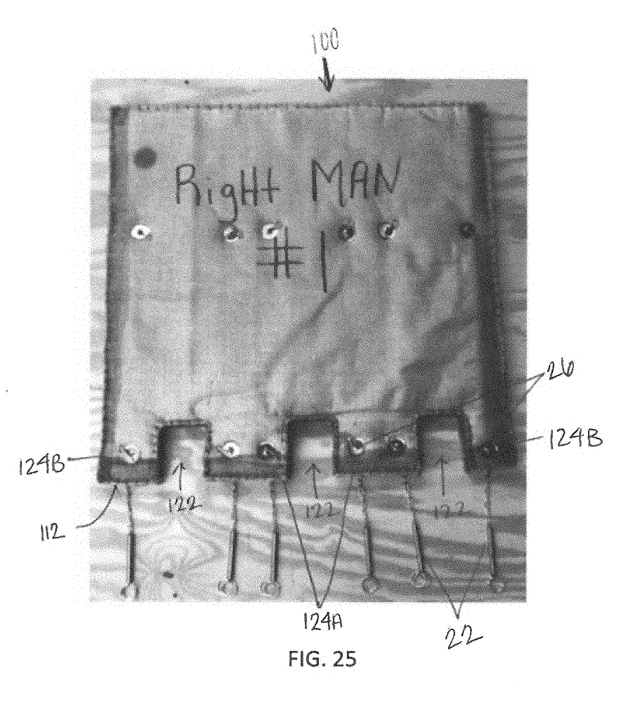

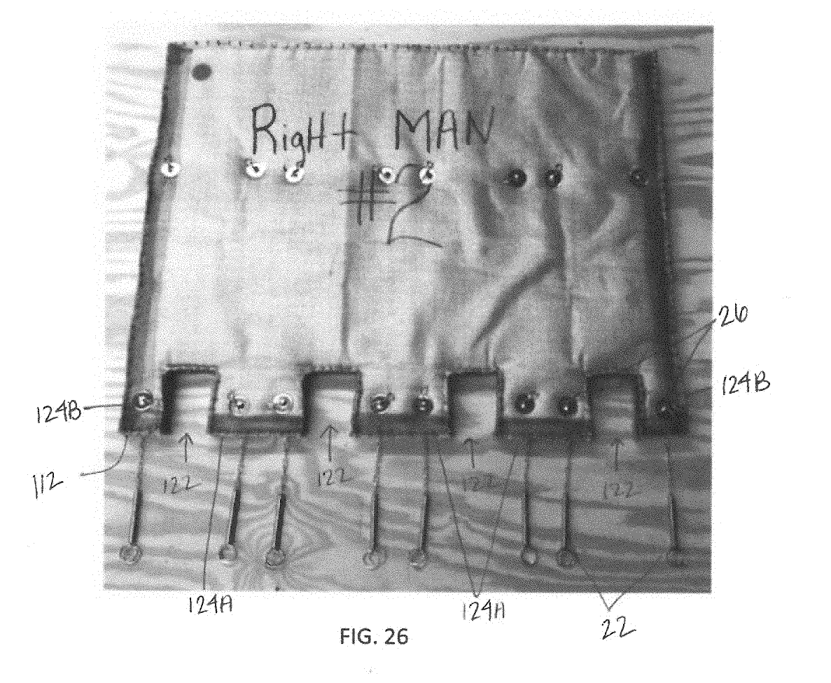

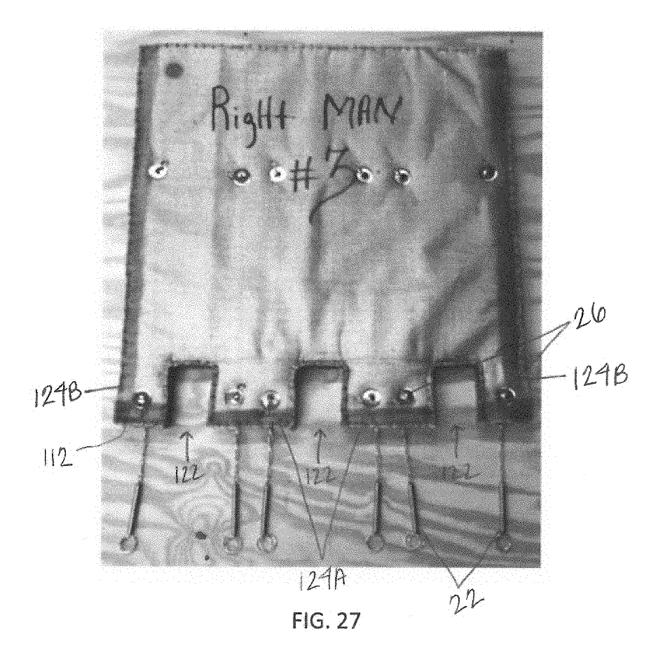

Referring now to FIGS. 25-27, there are shown top views of three side accessories 100 (a first side accessory 100 in FIG. 25, a second side accessory in FIG. 26, and a third side accessory 100 in FIG. 27). Each side accessory 100 has a general rectangular shape with one or more cutouts 122 along a first edge 112. In FIGS. 25 and 27, the side accessory 100 comprises three rectangular cutouts 122 along the first edge 112. Due to the cutouts 122, four protruding sections 124 are formed. In the depicted embodiment, there are two inner protruding sections 124A and two outer protruding sections 124B. The side accessory 100 shown in FIG. 26 comprises four rectangular cutouts 122 along the first edge 112. Due to the four cutouts 122, five protruding sections 124 are formed. In FIGS. 25-27, each inner protruding portion 124A comprises two stationary portions 26, such as lacing anchors and each outer protruding portion 124B comprises one stationary portions 26 (e.g., lacing anchors), as shown. As also shown in FIGS. 25-27, each side accessory 100 comprises one or more additional stationary portions 26 remote from the protruding sections 124. In addition, an opposing side (not shown) of each side accessory 100 (and protruding sections 124) also comprises a corresponding stationary portion (not shown) and a connected movable portion 22.

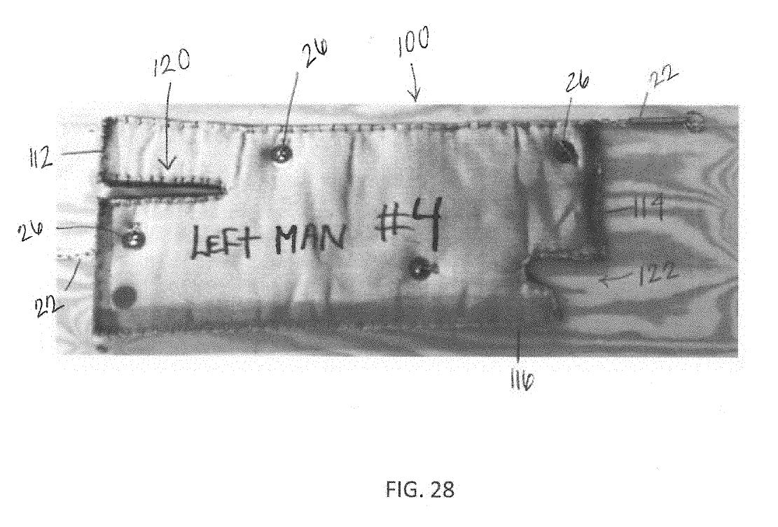

FIG. 28 shows a top view of a fourth side accessory 100. In the depicted embodiment, the fourth side accessory 100 has a general rectangular shape. FIG. 28 shows a slit 120 extending through a first edge 112 of the fourth side accessory 100. The fourth side accessory 100 additionally comprises a cutout 122 extending into a second edge 114 and a third edge 116 thereof. The second and third edges 114, 116 are adjacent, while the first edge 112 opposes the second edge 114, as shown. The fourth side accessory 100 may also comprise a plurality of stationary portions 26, such as lacing anchors. In addition, an opposing side (not shown) of the fourth side accessory 100 may also comprise a corresponding stationary portion (not shown) and a connected movable portion 22. In the depicted embodiment, a movable portion 22 extends from the first edge 112 and another movable portion 22 extends from the second edge 114 (or third edge 116).

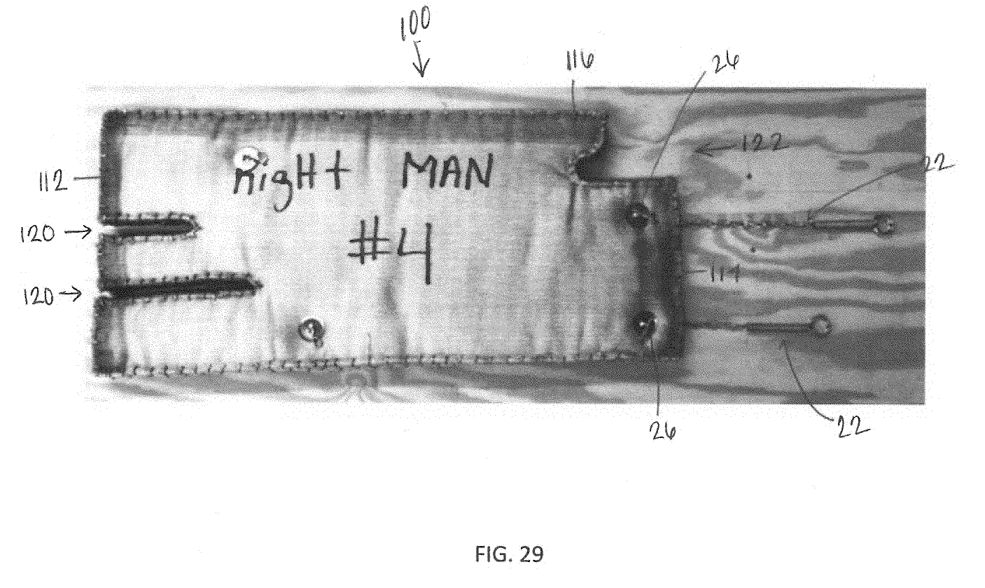

FIG. 29 shows a top view schematic representation of a fifth side accessory 100. In the depicted embodiment, the fifth side accessory 100 has a general rectangular shape. One or more slits 120 extend through a first edge 112 of the side accessory 100. In the depicted embodiment, the side accessory 100 comprises two slits 120 extending into the first edge 112. The side accessory 100 additionally comprises a cutout 122 extending into a second edge 114 and a third edge 116 thereof. The second and third edges 114, 116 are adjacent, while the first edge 112 opposes the second edge 114, as shown. The fifth side accessory 100 may also comprise a plurality of stationary portions 26, such as lacing anchors. In addition, an opposing side (not shown) of the fifth side accessory 100 may also comprise a corresponding stationary portion (not shown) and a connected movable portion 22. In the depicted embodiment, one or more movable portions 22 extend from second edge 114.

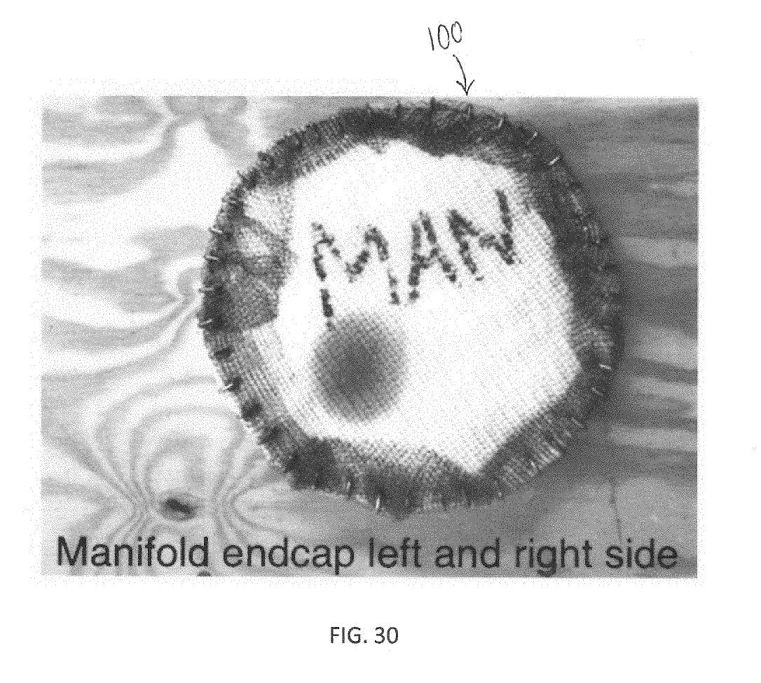

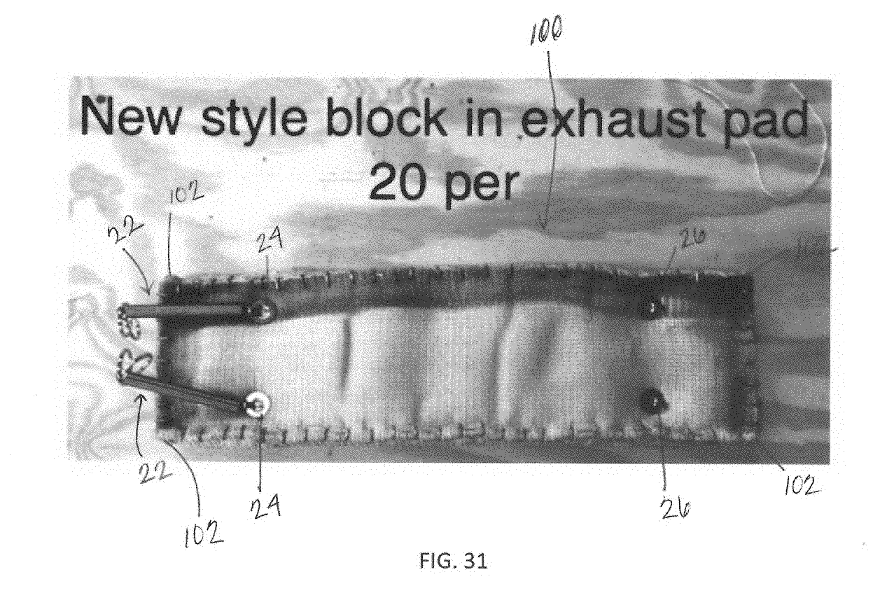

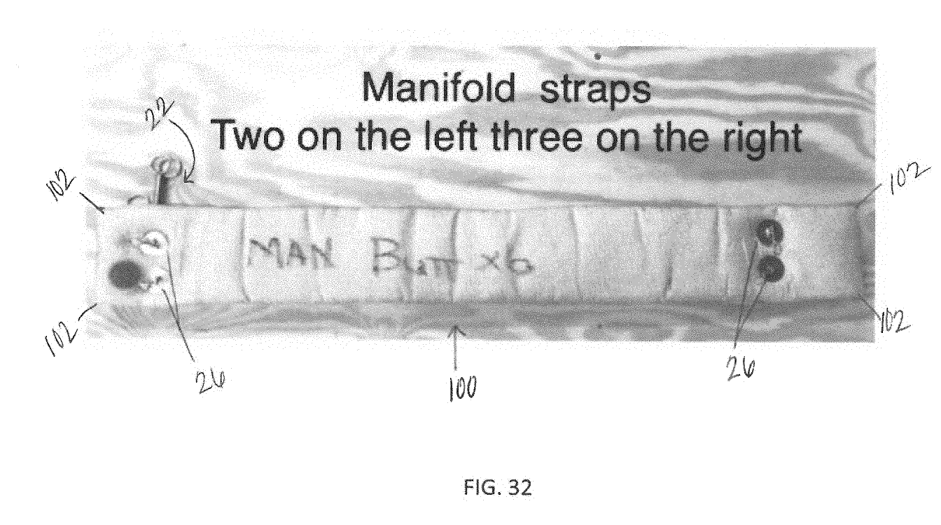

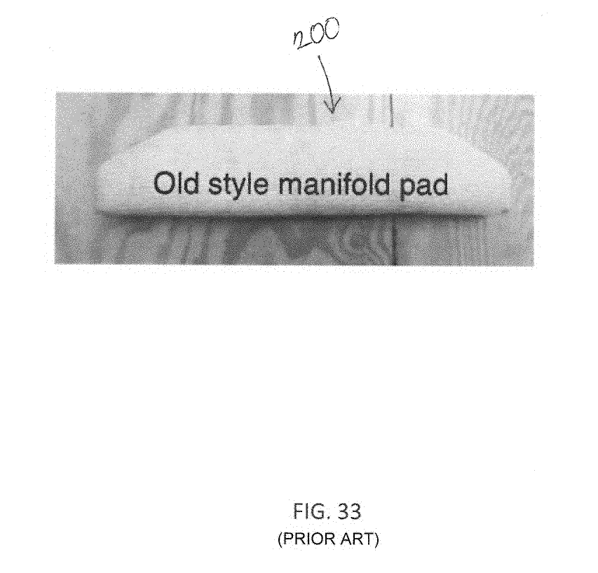

Turning now to FIG. 30, there is shown a top view of an end cap accessory 100, according to an alternative (e.g., “manifold”) embodiment. The end cap accessory 100 of FIG. 30 is circular. FIG. 31 shows an embodiment of an exhaust pad accessory 100. The exhaust pad accessory 100 is rectangular with one or more stationary portions 26, such as lacing anchors. In the depicted embodiment, there are two stationary portions 26, each near a corner 102 of the rectangular exhaust pad accessory 100. The corners 102 having the stationary portions 26 are adjacent. The exhaust pad accessory 100 may also comprise one or more movable portions 22 connected via a second set of stationary portions 24. In the depicted embodiment, the secondary set of stationary portions 24 are on an opposing side of the exhaust pad accessory as the two stationary portions 26 in the adjacent corners 102. FIG. 33 shows a conventional manifold pad 200. Conventional manifold pads 200 (FIG. 33) are inferior at insulating machines, such as industrial engines, because of their composite materials and lack of a mechanism (e.g., locking mechanism) for removably attaching to those machines. FIG. 32 shows an embodiment of a strap accessory 100. The strap accessory 100 is elongated and rectangular. In the depicted embodiment, there is one stationary portion 26 near each corner 102 of the rectangular strap accessory 100. In addition, an opposing side (not shown) of the strap accessory 100 may also comprise a corresponding stationary portion (not shown) and a connected movable portion 22.

All definitions, as defined and used herein, should be understood to control over dictionary definitions, definitions in documents incorporated by reference, and/or ordinary meanings of the defined terms.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as, “has” and “having”), “include” (and any form of include, such as “includes” and “including”), and “contain” (any form of contain, such as “contains” and “containing”) are open-ended linking verbs. As a result, a method or device that “comprises”, “has”, “includes” or “contains” one or more steps or elements. Likewise, a step of method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts and equivalents of all means or step plus function elements in the claims below, if any, are intended to include any structure, material or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the present invention for various embodiments with various modifications as are suited to the particular use contemplated.

What is claimed is:

1. A blanket system, comprising:
a blanket having:
a first layer composed of ceramic fibers,
a second layer composed of fiberglass cloth,
a third layer composed of wire mesh;
a first leading edge;
a second leading edge opposing and substantially parallel to the first leading edge; and
a locking mechanism having a movable portion between aligned first and second stationary portions on an outer surface of the blanket;
wherein in an unlocked position, the movable portion is connected to the first stationary portion and in a locked position, the movable portion is connected to both the first and second stationary portions and the locking mechanism extends over the first and second leading edges.

2. The system of claim 1, further comprising an auxiliary pad having one or more locking mechanisms.

3. The system of claim 1, wherein the movable portion comprises a spring.

4. The system of claim 1, wherein the first and second stationary portions comprise a lacing hook.

5. The system of claim 1, wherein the first layer is composed of only inorganic material.

6. The system of claim 1, wherein the first layer is heat resistant up to 2600° F.

7. The system of claim 1, wherein the second layer is heat resistant up to 1000° F.

8. The system of claim 1, wherein the wire mesh of the third layer is composed of wires having a diameter within the range of 0.001 to 0.006 inches.

9. The system of claim 1, wherein the wire mesh of the third layer is composed of stainless steel.

10. The system of claim 1, wherein the wire mesh of the third layer is composed of a nickel alloy.

11. The system of claim 1, wherein the wire mesh is heat resistant within the range of 900° F. to 1500° F.

12. The system of claim 1, wherein the wire mesh is heat resistant within the range of 2000° F. to 2300° F.

13. The system of claim 1, wherein the movable portion is connected to the first stationary portion by a chain.

14. The system of claim 1, wherein the movable portion is connected to the first stationary portion by a heat resistant cable.

15. The system of claim 3, further comprising a ring connected to the spring.
